(19) United States
(12) Patent Application Publication
(10) Pub. No.: US 2006/0290746 A1
(43) Pub. Date: Dec. 28, 2006

(54) Array printhead having micro heat pipes

(76) Inventor: Nam-kyun Kim, Seongnam-si (KR)

Correspondence Address: STANZIONE & KIM, LLP, 919 18TH STREET, N.W., SUITE 440, WASHINGTON, DC, 20006, US

(21) Appl. No.: 11/325,324

(22) Filed: Jan. 5, 2006

(30) Foreign Application Priority Data
Jun. 22, 2005 (KR) 2005-54067

(51) Int. Cl. B41J 2/05

(52) U.S. Cl. 347/67; 347/56

(57) ABSTRACT

An array printhead has a plurality of head chips arranged in a predetermined configuration. Each of the head chips in the array printhead includes a substrate having a surface on which are formed a plurality of heaters and a plurality of wire electrodes to supply an electric current to the plurality of heaters, a chamber layer stacked on the substrate and having a plurality of ink chambers filled with ink to be ejected, a nozzle layer stacked on the chamber layer, having a plurality of nozzles through which the ink in the ink chamber is ejected; and one or more micro heat pipe to dissipate accumulated heat outside the substrate, formed on an exposed surface of the substrate.

### CROSS-REFERENCE TO RELATED APPLICATIONS

This application claims the benefit under 35 U.S.C. § 119 of Korean Patent Application No. 2005-54067, filed on Jun. 22, 2005, in the Korean Intellectual Property Office, the disclosure of which is incorporated herein in its entirety.

### BACKGROUND OF THE INVENTION

1. Field of the Invention

The present general inventive concept relates to a printhead of an inkjet printer, and more particularly, an array printhead of a line printing type inkjet printer, which has micro heat pipes to dissipate heat.

2. Description of the Related Art

In general, an inkjet printer prints color images on a print medium by ejecting ink from a printhead on desired regions of the print medium. Inkjet printers are classified into two types: thermal inkjet printers ejecting ink due to an expansion force of bubbles generated by heating the ink with a heater; and piezoelectric inkjet printers ejecting ink due to a pressure applied to the ink as a result of a deformation of a piezoelectric body.

Among various types of thermal inkjet printers, a shuttle type inkjet printer whose printhead reciprocates in a direction perpendicular to a direction of transporting a print medium to print an image has been typically used. The printhead of the shuttle type inkjet printer is formed of a single head chip having a plurality of nozzles ejecting ink.

Recently, a line printing type inkjet printer having a page-wide array printhead corresponding to a width of a print medium has been developed to achieve a high-speed printing. The page-wide array printhead has a plurality of head chips arranged in a predetermined configuration, and each of the plurality of head chips has a plurality of nozzles ejecting ink. In the line printing type inkjet printer, during printing, the page-wide array printhead is fixed and the print medium is transported underneath, thereby allowing the high-speed printing.

However, when printing, more heat is generated in the page-wide array printhead of the line printing type inkjet printer than in the printhead of the shuttle type inkjet printer, and thus heat accumulates in the plurality of head chips, which results in deterioration of a process of ejecting ink due to an expansion force of bubbles generated by heating the ink. Consequently, a driving frequency to eject ink from the page-wide printhead is decreased and the printing quality is degraded.

### SUMMARY OF THE INVENTION

The present general inventive concept provides an array printhead having micro heat pipes to dissipate heat, which is used in a line printing type inkjet printer.

The foregoing and/or other aspects of the present general inventive concept are achieved by providing an array printhead having a plurality of head chips arranged in a predetermined configuration, each of the plurality of head chips including a substrate having a surface on which are formed a plurality of heaters and a plurality of wire electrodes to supply an electric current to the plurality of heaters, a chamber layer stacked on the substrate and having a plurality of ink chambers filled with ink to be ejected , a nozzle layer stacked on the chamber layer and having a plurality of nozzles through which the ink from the plurality of ink chambers is ejected; and one or more micro heat pipes to dissipate accumulated heat outside the substrate are formed on an exposed surface of the substrate.

The one or more micro heat pipes may be formed along opposite sides of the exposed surface of the substrate.

The array printhead may further include one or more heat sinks in contact with the one or more micro heat pipes.

Each of the one or more micro heat pipes may include a sealed container, a working fluid contained in the sealed container, and capillary tube structures formed on inner walls of the sealed container to transport the working fluid by capillary action. Here, the capillary tube structures may be porous or have a plurality of grooves formed on the inner walls of the sealed container.

The substrate may be perforated to form ink passages through which ink is supplied to the ink chambers.

The foregoing and/or other aspects of the present general inventive concept are also achieved by providing an array printhead having a plurality of head chips arranged in a predetermined configuration, each of the plurality of head chips including a substrate having a surface on which are formed a plurality of heaters and a plurality of wire electrodes to supply an electric current to the plurality of heaters, a chamber layer stacked on the substrate and having a plurality of ink chambers filled with ink to be ejected, a nozzle layer stacked on the chamber layer, having a plurality of nozzles through which the ink in the ink chamber is ejected; and a plurality of micro heat pipes to dissipate accumulated heat outside through the nozzle layer are formed on a surface of the substrate.

Here, the chamber layer may be perforated to form the plurality of micro heat pipes reaching the nozzle layer. The nozzle layer may be formed of a metal plate metal plate having good thermal conductivity.

The foregoing and/or other aspects of the present general inventive concept are also achieved by providing a wide-page printhead having a substrate, a chamber storing ink and a plurality of nozzles that eject ink heated by heaters, the wide-page printhead including a plurality of micro heat pipes to dissipate heat generated by the plurality of heaters.

The foregoing and/or other aspects of the present general inventive concept are also achieved by providing a wide-page printhead having a substrate, and a plurality of head chips each having nozzles that eject ink heated by corresponding heaters, each head chip of the plurality of head chips including a plurality of micro heat pipes to dissipate heat, wherein each heat pipe of the plurality of micro heat pipes has a first surface in contact to the substrate of the head chip where the heaters are formed and having a first temperature so that the working fluid evaporates when in contact to the first surface, and a second surface opposite to the first surface and having a second temperature that is lower than the first temperature so that the working fluid condenses when in contact to the second surface.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a plan view of an array printhead in a line printing type inkjet printer according to an embodiment of the present general inventive concept;

FIG. 2 is a perspective view of a head chip included in the array printhead illustrated in FIG. 1;

FIG. 3 is a plan view of a substrate of the head chip illustrated in FIG. 2;

FIG. 4 is a schematic cross-sectional view of a micro heat pipe mounted on the substrate of the head chip illustrated in FIG. 3; and

FIG. 5 is a plan view illustrating a substrate of a head chip in an array printhead according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. In the drawings, the sizes and thicknesses of layers and regions are exaggerated for clarity. It should also be understood that when a layer is referred to as being “on” another layer or substrate, it can be disposed directly on the other layer or substrate, or intervening layers may also be present.

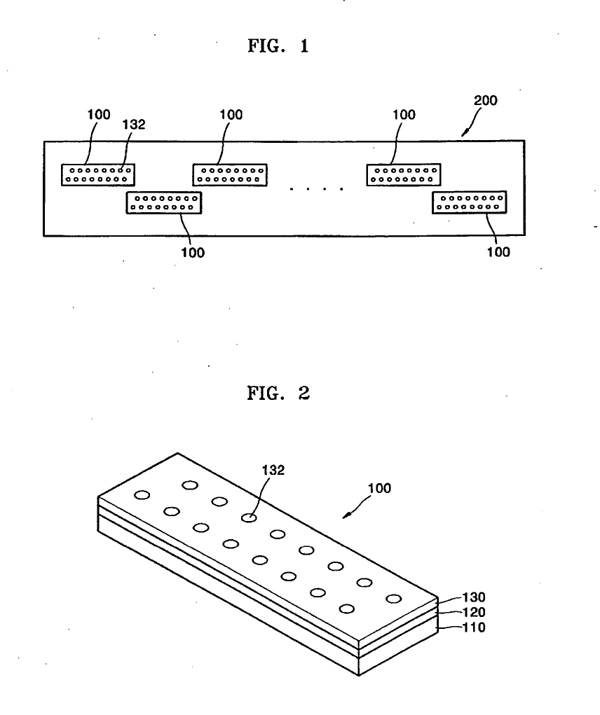

FIG. 1 is a plan view of an array printhead 200 in a line printing type inkjet printer according to an embodiment of the present general inventive concept. Referring to FIG. 1, the array printhead 200 includes a plurality of head chips 100 arranged in a predetermined configuration. The plurality of head chips 100 are arranged in two lines in the array printhead 200 illustrated in FIG. 2, but the present general inventive concept is not intended to be limited to the illustrated arrangement, and the plurality of head chips 100 may also be arranged in one, three or more lines. In addition, the arrangement and the number of head chips 100 in the array printhead can be varied. Each head chip of the plurality of head chips 100 includes a plurality of nozzles 132.

FIG. 2 is a perspective view of one head chip of the plurality of head chips 100 in the array printhead 200 illustrated in FIG. 1. Referring to FIG. 2, each of the plurality of head chips 100 in the array printhead 200 includes a substrate 110, a chamber layer 120 stacked on the substrate 110, and a nozzle layer 130 stacked on the chamber layer 120. A silicon substrate is generally used for the substrate 110. A plurality of ink chambers (not illustrated), which are filled with ink to be ejected, are formed in the chamber layer 120. A plurality of nozzles 132, through which the ink is ejected from the plurality of ink chambers, are formed in the nozzle layer 130.

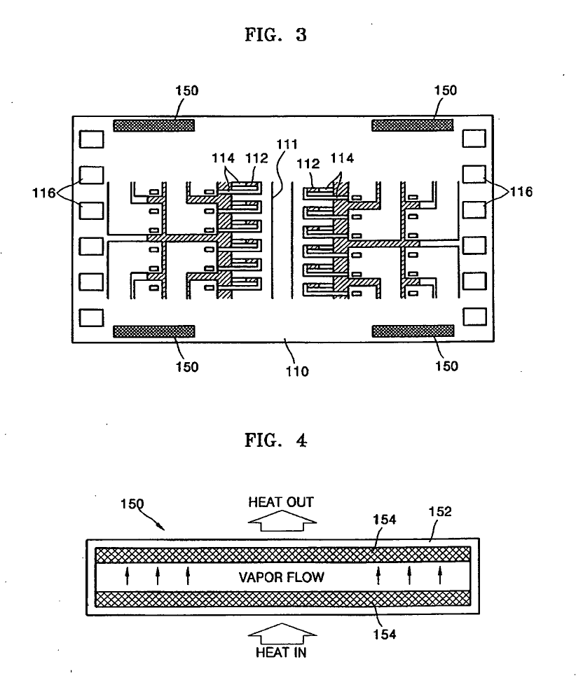

FIG. 3 is a plan view of the substrate 110 of the head chip illustrated in FIG. 2. Referring to FIG. 3, a plurality of heaters 112 and a plurality of wire electrodes 114 that are electrically connected to respective ones of the plurality of heaters 112 are formed on a surface of the substrate 110 to correspond to the respective ink chambers formed in the chamber layer 120. The plurality of heaters 112, which can be formed of heating resistors, heat the ink in the ink chambers to generate bubbles. The plurality of wire electrodes 114, formed of conductors having excellent electric conductivity, are used to supply electric currents to the plurality of heaters 112. In addition, the substrate 110 is perforated to form ink passages 111 through which ink is supplied to each of the ink chambers in the chamber layer 120. When an ink chamber is filled with ink through the ink passage 111 and an electric current is supplied to the corresponding heater 112 of the ink chamber through a corresponding one of the wire electrodes 114, the corresponding heater 112 heats the ink in the ink chamber up to a predetermined temperature to generate a bubble. The expansion force of the bubble ejects the ink in the ink chamber outside of the chamber through a nozzle 132.

Sides of the substrate 110 are exposed outside of the head chip. As illustrated in FIG. 3, a plurality of pads 116 used to electrically connect the head chip 100 to an external circuit system (not illustrated) are formed along opposite sides of the surface of the substrate 110. Here, the plurality of pads 116 are electrically connected to corresponding one of the plurality of wire electrodes 114.

One or more micro heat pipes 150 are formed along opposite sides of the surface of the substrate 110. The micro heat pipes 150 dissipate accumulated heat generated by the plurality of heaters 112 in the substrate 110 away from the substrate 110. A micro heat pipe 150, generally used in small electric devices as a heat dissipating element, transfers heat by continually changing a phase state of a working fluid that is stored in a sealed container between gas and liquid. Such a micro heat pipe has an excellent thermal transfer compared to other heat dissipating elements having a single-phase working fluid.

FIG. 4 is a schematic cross-sectional view illustrating an embodiment of the micro heat pipe 150 included in the head chip illustrated in FIG. 3. Referring to FIG. 4, the micro heat pipe 150 includes a sealed container 152, a working fluid contained in the sealed container 152, and capillary tube structures 154 formed on inner walls of the sealed container 152. A bottom wall of the sealed container 152 contacts a surface of the substrate 110. The capillary tube structures 154, in which the working fluid can perform a capillary action, may include porous structures like wicks or a plurality of grooves formed of an inner side of the bottom wall of the sealed container 152. When the heat accumulated in the substrate 110 is transferred to the micro heat pipe 150 through the outer bottom wall on the sealed container 152, the phase of the working fluid in the capillary tube structure 154 is changed from liquid to gas by the transferred heat. The gas of the working fluid moves up to a top wall of the sealed container 152, which is in contact with an outside lower temperature, and the working fluid is then cooled down and changes back into a liquid state. Thus, a latent heat of the gas-to-liquid phase change is dissipated outside through the top wall of the sealed container 152. The working fluid in the liquid state flows into the capillary tube structure 154 by capillary action. By continual repeating of the phase change of the working fluid, the heat accumulated in the substrate 110 can be efficiently dissipated outside. Although the working fluid in the micro heat pipe 150 is described as being returned by capillary action, according to alternative embodiments of the present general inventive concept, the working fluid in the micro heat pipe 150 can also be returned due to an osmotic pressure, an electrostatic force, or a magnetic force. The micro heat pipes 150 may be differently arranged from the arrangement illustrated in FIG. 3 to effectively dissipate heat. The micro heat pipes arrangement illustrated in FIG. 3 is merely illustrative, and is not intended to be limiting to the present general inventive concept. Alternatively, the micro heat pipes 150 may be connected to heat sinks to further effectively dissipate the heat that is accumulated in the substrate 110.

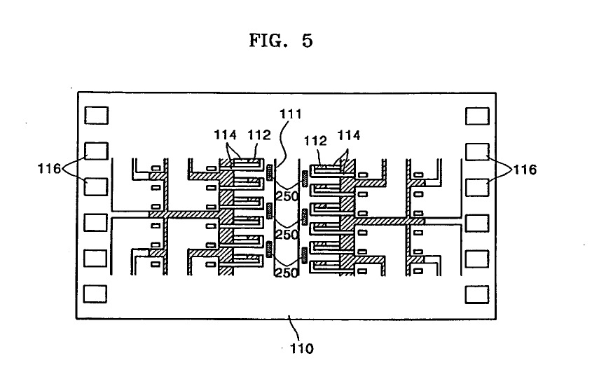

FIG. 5 is a plan view illustrating a substrate of a head chip in an array printhead according to another embodiment of the present general inventive concept. Hereinafter, the present embodiment is described with respect to differences from the above-described embodiment.

Referring to FIG. 5, the plurality of heaters 112 and the plurality of wire electrodes 114 that are electrically connected to the plurality of heaters 112 are formed on the surface of the substrate 110. The substrate 110 is perforated to form an ink passage 111 through which ink is supplied to each of ink chambers in the chamber layer 120 (see FIG. 2). A plurality of pads 116 that are used to electrically connect the head chip 100 (see FIG. 1) to an external circuit system (not illustrated) are formed along opposite sides of the surface of the substrate 110. Here, the plurality of pads 116 are electrically connected to respective wire electrodes of the plurality of electrodes 114.

A plurality of micro heat pipes 250 are formed on the surface of the substrate 110 near the plurality of heaters 112. Since a structure of each micro heat pipe 250 is similar to a structure of the above-described micro heat pipe 150 of the previous embodiment, a description thereof will be omitted. The chamber layer 120 (see FIG. 2) is perforated to install the micro heat pipes 250 whose upper surfaces contact the nozzle layer 130. Accordingly, heat locally accumulated near the plurality of heaters 112 in the substrate 110 is transferred to the nozzle layer 130 through the plurality of micro heat pipes 250 and dissipated outside. The nozzle layer 130 may be formed of a material having good thermal conductivity, such as a metal plate to dissipate heat effectively.

In an array printhead in a line printing type inkjet printer according to various embodiments of the present general inventive concept, micro heat pipes to dissipate heat are formed along exposed opposite sides of a surface of a substrate or on a surface of the substrate near heaters, thereby effectively dissipating heat accumulated in the substrate due to heating by the heaters when printing, to allow an increase in the driving frequency and better print quality. In addition, since the micro heat pipes can be formed using a method of forming electronic circuit elements on the surface of the substrate, the process of manufacturing the micro heat pipes can be simplified.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An array printhead having a plurality of head chips arranged in a predetermined configuration, each of the plurality of head chips comprising:
a substrate having a surface on which are formed a plurality of heaters and a plurality of wire electrodes to supply an electric current to the plurality of heaters;
a chamber layer stacked on the substrate and having a plurality of ink chambers filled with ink to be ejected;
a nozzle layer stacked on the chamber layer and having a plurality of nozzles through which the ink from the plurality of ink chambers is ejected; and
one or more micro heat pipes to dissipate accumulated heat outside the substrate formed on an exposed surface of the substrate.

2. The array print head of claim 1, wherein each of the one or more micro heat pipes are formed along opposite sides of the exposed surface of the substrate.

3. The array print head of claim 1, further comprising one or more heat sinks in contact with the one or more micro heat pipes.

4. The array print head of claim 1, wherein the one or more micro heat pipes comprise:
a sealed container;
a working fluid contained in the sealed container; and
capillary tube structures formed on inner walls of the sealed container to transport the working fluid by capillary action.

5. The array print head of claim 4, wherein the capillary tube structures are porous or comprise a plurality of grooves formed on the inner walls of the sealed container.

6. The array print head of claim 1, wherein the substrate is perforated to form ink passages through which ink is supplied to the ink chambers.

7. An array printhead having a plurality of head chips arranged in a predetermined configuration, each of the plurality of head chips comprising:
a substrate having a surface on which are formed a plurality of heaters and a plurality of wire electrodes to supply an electric current to the plurality of heaters;
a chamber layer stacked on the substrate and having a plurality of ink chambers filled with ink to be ejected;
a nozzle layer stacked on the chamber layer and having a plurality of nozzles through which the ink in the ink chamber is ejected; and
a plurality of micro heat pipes to dissipate accumulated heat outside through the nozzle layer are formed on a surface of the substrate.

8. The array print head of claim 7, wherein the chamber layer is perforated to form the plurality of micro heat pipes reaching the nozzle layer.

9. The array print head of claim 7, wherein the nozzle layer is formed of a metal plate having thermal conductivity.

10. The array print head of claim 7, wherein each of the plurality of micro heat pipes comprises:
a sealed container;
a working fluid contained in the sealed container; and
capillary tube structures formed on inner walls of the sealed container to transport the working fluid by capillary action

11. The array print head of claim 10, wherein the capillary tube structures are porous or comprise a plurality of grooves formed on the inner walls of the sealed container.

12. The array print head of claim 7, wherein the substrate is perforated to form an ink passage through which ink is supplied to the plurality of ink chambers.

13. A wide-page printhead having a substrate, chambers storing ink and a plurality of nozzles that eject ink heated by heaters, the wide-page printhead comprising:
a plurality of micro heat pipes to dissipate heat generated by the heaters.

14. The wide-page printhead of claim 13, wherein each micro heat pipe of the plurality of micro heat pipes is a container filled with a working fluid, the container comprising:
a first surface in contact with the substrate of the wide-page printhead and the working fluid evaporates when in contact with the first surface; and
a second surface opposite to the first surface and having a temperature that is lower than a temperature of the first surface so that the working fluid condenses when in contact with the second surface.

15. The wide-page printhead of claim 14, wherein the temperature of the first surface is equal to or higher than an evaporation temperature of the working fluid, and the temperature of the second surface is equal to or lower than a condensation temperature of the working fluid.

16. The wide-page printhead of claim 14, wherein each micro heat pipe of the plurality of micro heat pipes further comprises:
capillary tubes structures disposed on the first surface and the second surface inside the micro heat pipe to move the working fluid by capillary action towards the first and the second surface.

17. The wide-page printhead of claim 16, wherein the capillary tube structures comprise either a plurality of grooves or are porous.

18. The wide-page printhead of claim 14, wherein each of the plurality of micro heat pipes moves the working fluid to and/or from the first and second surface using one of an osmotic pressure, an electrostatic force and a magnetic force.

19. The wide-page printhead of claim 14, wherein the plurality of micro heat pipes are disposed along opposite sides of a substrate of the wide-page printhead where the plurality of heaters are formed having the second surface outside.

20. The wide-page printhead of claim 14, wherein the plurality of micro heat pipes are disposed near the plurality of respective heaters having the second surface in contact to a nozzle surface of the wide-page printhead where the plurality of nozzles is formed.

21. The wide-page printhead of claim 20, wherein the nozzle surface of the wide-page printhead is metallic.

22. The wide-page printhead of claim 14, wherein the second surface of each micro heat pipe of the plurality of micro heat pipes is in contact with a heat sink.

23. A wide-page printhead having a substrate and a plurality of head chips each having nozzles that eject ink when heated by corresponding heaters, each head chip of the plurality of head chips comprising:
a plurality of micro heat pipes to dissipate heat, wherein each micro heat pipe of the plurality of micro heat pipes comprises:
a first surface in contact with the substrate of the head chip where the heaters are formed and having a first temperature so that the working fluid evaporates when in contact to the first surface; and
a second surface opposite to the first surface and having a second temperature that is lower than the first temperature so that the working fluid condenses when in contact to the second surface.

24. The wide-page printhead of claim 23, wherein the head chips are arranged in one or more lines on the wide-page printhead.
